(19) United States
(12) Patent Application Publication
(10) Pub. No.: US 2012/0150576 A1
(43) Pub. Date: Jun. 14, 2012

(54) INTEGRATING SIMULATION AND FORECASTING MODES IN BUSINESS INTELLIGENCE ANALYSES

(75) Inventor: Timo Wagenblatt, Erfweiler (DE)

(73) Assignee: SAP AG, Walldorf (DE)

(21) Appl. No.: 12/963,034

(22) Filed: Dec. 8, 2010

(51) Int. Cl. G06Q 10/00

(52) U.S. Cl. 705/7.12; 705/7.11

(57) ABSTRACT

An optimization object may include fields storing parameters used by the intelligence system during business intelligence data analysis. One of these fields may include a mode type field to selectively switch between a forecasting mode to extrapolate a value from the data and a simulation mode including an optimization module to calculate a value from the data expected to maximize a particular objective. Stored parameters may include common parameters used in both modes and unique parameters to one of the two modes. Optimization modules may include an option to output a variable number of secondary recommendations in addition to a best recommendation. Parameters and results of models may be saved and later retrieved or compared to identify differences between the parameters and results of compared models. Visual scheduling arrangements may be modified to show certain results from the data analyses.

### BACKGROUND

Many organizations use business intelligence systems to analyze business data and provide additional quantitative information used in decision making. For example, businesses may use intelligence system to forecast future sales of a product based on an analysis of past sales data. Businesses may also use intelligence systems to forecast the effect of a discount, sale, or other trade promotion on product sales. This data may be used by organizations to determine when and if it is cost effective for businesses to offer different trade promotions such as including a free bonus quantity of product; providing rebates, coupons, or other discounts; or increasing advertising or product promotion.

Business intelligence systems may use different algorithms and tools to analyze the effects of a trade promotion on an organization. For example, some of these systems may use regression or time series models to extrapolate the effect of a trade promotion on future sales.

Other intelligence systems may not predict the effect of a trade promotion, but may use optimization algorithms to identify a particular trade promotion out of many different possible promotions that is expected to maximize profit, revenue, or another objective for the organization. Intelligence systems performing optimization functions have been totally separate from and independent of the business intelligence systems performing the forecasting functions.

Business intelligence systems may use forecasting and simulations in other contexts beyond trade promotions as well. For example, an organization may want to forecast an effect of a change in tax rates or disposable income on revenue. As another example, the organization may use a simulation to determine optimal pricing adjustments in view of changes in tax rates or disposable income to maximize revenue. Thus, the trade promotion context is just one example of how organizations may use forecasting and simulation functionality.

While optimization functionality has generally been used to identify a single “best case” set of conditions that maximize (or minimize) a particular objective, in some instances organizations may want to select from additional alternative conditions that may be more desirable for other reasons even though they may not maximize the particular objective as well as the “best case.” For example, if the best case conditions selected during the optimization are impractical, inconsistent with other activities or goals, or not favored for other reasons, the organization may want to select a second tier or even third tier set of conditions that address these considerations.

The separation between intelligence systems performing simulation through optimization functions and those performing forecasting functions has caused inefficiencies for users of these systems. For example, users wanting to switch between forecasting and simulation modeling have to reenter and reconfigure parameters separately in each system. Because the systems are separate, it is difficult to superimpose output, such as graphs and other visual data, from both the forecasting and optimization models. Additionally, existing forecasting and optimization models make it difficult to quickly see the effects of timing in Gantt charts, calendars, and other visual scheduling arrangements of any forecasts, simulations, or optimizations. Furthermore, it is also difficult to see the effect of a parameter change in one model on the other model, since the systems are independent and separate. Finally, it is also difficult to compare different forecasts, simulations, and optimizations to quickly see the effects of a parameter change on the output of each model.

There is a need for integrated optimization, simulation and forecasting modeling functionality to enable easy switching and data sharing between the models. There is also a need for optimization modeling systems to output multiple solutions, including second tier solutions. There is also a need for a user to be able to quickly see in a Gantt chart, calendar, or other visual scheduling arrangement any timing implications of any forecasts, simulations, or optimizations. Finally, there is also a need to save, retrieve, and compare model outputs and parameters to identify the effects of parameter changes on model output.

### BRIEF DESCRIPTION OF THE DRAWINGS

FIG. 1 shows exemplary fields of a trade promotion optimization object in an embodiment of the invention.

FIG. 2 shows exemplary parameter fields of a trade promotion optimization object in an embodiment of the invention.

FIG. 3 shows exemplary output of a trade promotion optimization object in an embodiment of the invention.

FIG. 4 shows exemplary communications between different systems in an embodiment of the invention.

FIG. 5 shows an exemplary process in an embodiment of the invention.

FIG. 6 shows an embodiment of an enterprise system coupled to an inventory/CRM system and business intelligence system through a bus or network.

FIG. 7 shows an exemplary visual scheduling arrangement in an embodiment

FIG. 8 shows an exemplary process for modifying the visual scheduling arrangement in an embodiment.

FIG. 9 shows an exemplary modified visual scheduling arrangement in an embodiment.

FIG. 10 shows an exemplary interface for managing the retrieval and comparison of saved model parameters and results in an embodiment.

FIG. 11 shows an exemplary process for comparing the selected models in an embodiment.

FIG. 12 shows exemplary output of comparing the parameters and results of different saved models in an embodiment.

### DETAILED DESCRIPTION

In an embodiment of the invention, a trade promotion optimization object may include fields storing parameters used by the intelligence system during trade promotion analysis. One of these fields may include a mode type field to selectively switch between a forecasting mode to extrapolate a value from a set of data and a simulation mode including an optimization module to calculate a value from the set of data expected to maximize a particular objective. In some situations, only some of the data in the set of data may be used, and different data may be used to in each respective mode. The stored parameters may include common parameters used in both forecasting and simulation modes and unique parameters to one of the two modes. The trade promotion object may also include fields specifying details of the promotion, such as products or accounts involved in the promotion. The analysis mode selected in the type field may be executed on data relating to the promotion details fields of the object subject to the parameters in the corresponding parameter fields.

A result of the analysis may be stored in output fields of the object. If the optimization module is invoked, the output fields may be used to store the top solutions to the optimization conditions based on the number of solutions requested by user. Thus, if a user wants to see n solutions, then the n best solutions as calculated by the optimization module may be stored in the output fields. The output fields may include data provided in a dashboard to visually display, such as through graphs and charts, a result of the analysis. In some instances, the dashboard may superimpose results from different analyses including, for example, a simulation analysis superimposed over a forecasting analysis.

In situations where a visual scheduling arrangement, such as a Gantt chart, calendar, or timeline, is used, the results of the analysis may be used to modify the visual scheduling arrangement to show an effect of time on the results. For example, a time period in the visual scheduling arrangement corresponding to an optimized time for conducting or not conducting an activity, as calculated by the optimization module, may be demarcated in the visual scheduling arrangement. The terms demarcate, demarcating, and demarcation may refer to delimiting time periods, marking boundaries of time periods, setting apart time periods, or otherwise differentiating time periods, such as by highlighting, emphasizing, or distinguishing particular time periods satisfying a particular criterion. Other results may also be visually depicted in the visual scheduling arrangement. For example, fluctuations in expected values of forecasts over time may be shown in the visual scheduling arrangement by using different indicators to represent different values.

Each forecasting, simulation, and optimization model that is executed may be saved. The data that may be saved for each executed model may include the parameter values selected for the model and the results of executing the model. The saved model data may then be subsequently retrieved and displayed. The saved model data may also be compared to other model data. During the comparison, the saved parameter values and results of each selected model may be compared to those of other selected models to identify differences between the models. The differences between the results and parameter values in each selected model may then be presented to the user and/or analyzed to extrapolate a trend or other relationship between the changes in parameter values and the corresponding results.

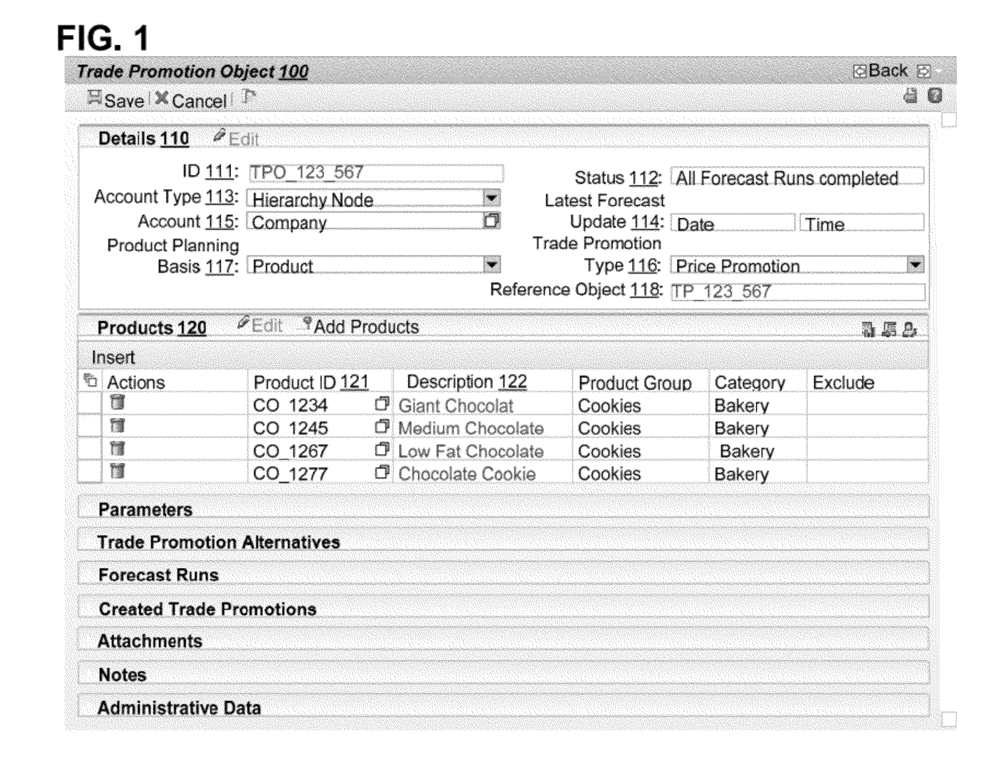

FIG. 1 shows exemplary fields of a trade promotion optimization object 100 displayed in a user interface of an embodiment of the invention. The fields may include detail related fields 110, such as an identifier field 111, status field 112, account type field 113, latest forecast update field 114, account field 115, trade promotion type field 116, product planning basis field 117, and reference object field 118. Trade promotion object 100 may also include a products field 120 that may include an identifier 121 of one or more products involved in the promotion. The product identifier 121 may also be used to obtain additional information about the product, such as a product description 122, group 123, and category 124. Product information may be obtained from another enterprise system in the organization, such as an enterprise resource planning (ERP) system, inventory management system, or a data warehouse system.

The identifier field 111 may include an identifier of a particular trade promotion optimization object, so that each trade promotion optimization object may be uniquely identified. In some instances, an identifier in the identifier field 111 may be created based on a reference object specified in the reference object field 118. The reference object field 118 may include an identifier of object in another application that was used to create an instance of a trade promotion optimization object. For example, if another application is used to process a deal agreement between two parties, such as a retailer and a manufacturer, and an object in other application instantiates a trade promotion optimization to extrapolate an effect of the deal, then an identifier of object in the other application may be included in the reference object field 118. The identifier included in the reference object field 118 may also be used to derive an identifier for the trade promotion optimization instance in the identifier field 111. For example, the reference object field 118 has a value of TP_123_567 while the identifier field 111 has a value of TPO_123_567, which is derived from TP_123_567.

The status field 112 may include a current status of the trade promotion optimization instance. The last forecast update field 114 may identify a time that the optimization analysis is last updated. These fields 112 and 114 may be updated synchronously or asynchronously. In some instances the status field 112 and last forecast update field 114 may be used to maintain a proper sequence of events by being accessed to determine if the optimization instance is in a suitable state before proceeding to a subsequent phase. For example, the status field 112 may be checked to determine whether all forecasting scenarios are complete before performing further analysis, while the last forecast update field 114 may be checked to determine whether the data used in the analysis is still fresh or whether the analysis should be repeated with more recent data.

The account type field 113 may identify a structure of data included in an account so that relevant data in the account may be properly accessed and analyzed. The account type field 113 provides different mappings enabling interactivity with different computing systems and applications specifying different data structures for accounts. The mappings may be used to identify the location of specific data in each of the data structures.

The account field 115 may identify an account belonging to a specific business partner involved in the trade promotion. For example, if the promotion involves certain household goods sold at a retailer then data in the account field 115 may identify the retailer's account involving the household goods.

The trade promotion type field 116 may identify the type of promotion. For example, promotions offering a quantitative discount may be identified as price promotions while promotions involving retail displays, advertising, or free samples may be identified as marketing promotions. Other types of promotions may be included in different embodiments. The trade promotion type field 116 may be used during optimization analysis to differentiate between different types of promotions and/or select one or more different types of trade promotions for further analysis. The product planning basis field 117 may identify a criteria on which future decisions are made.

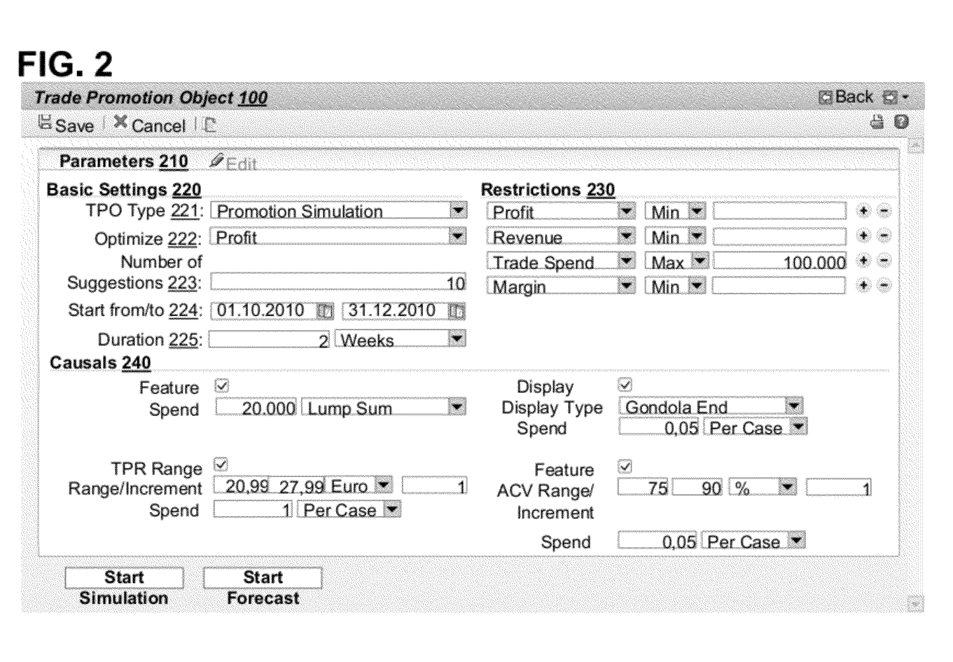

FIG. 2 shows exemplary parameter fields 210 of a trade promotion object 100 displayed in a user interface of an embodiment of the invention. The parameter fields may include basic setting fields 220, restriction fields 230, and causal fields 240. In some embodiments, these fields 220, 230, and 240 may be selected by a user. A user may be a business person operating a computer at a front-end of a processing system, such as processing system 410. For example, in an embodiment, the user may specify one or more of the parameters 210.

Basic setting fields 220 may include fields pertaining to the range and type of analysis that is to be performed. Basic setting fields 220 may include a trade promotion analysis mode type field 221, an optimization field 222, an output limit field 223, a range field 224, and duration 225.

The analysis mode type field 221 may identify a selected type of optimization analysis that is to be performed. The types of optimization analyses may include single promotion forecasting, multiple promotion forecasting, scenario forecasting, and promotion simulation.

Single promotion forecasting may predict a future effect of a single promotion. The predicted future effect may include an effect on sales of the product, an effect on revenue, an effect on profit, or any other quantifiable effect.

Multiple promotion forecasting may predict a future effect of more than one promotion. In this case, the predicted future effect may include not only the predicted effect of each promotion individually, but also additional inter-promotion effects, such as the effect that one promotion has on product sales in view of the other promotions.

Scenario forecasting may predict a future effect of adding, deleting, or change a trade promotion in view of other planning trade promotions. The primary difference between multiple promotion forecasting and scenario forecasting is that in multiple promotion forecasting each of the promotions are variable and the output may be presented as a single output for the multiple promotions. In scenario forecasting, there are fixed promotions and variable promotions that may be adding, deleted, or changed. The output in scenario forecasting may be presented as relative to the fixed promotion so that an effect of changing a variable promotion may be easily observed.

Promotion simulation may simulate the effects of different trade promotions. For example, promotion simulation may simulate the effect of offering different discounts on product revenue, such as different discounts between 0% and 30%. Alternatively, promotion simulation may simulate the effect of spending different amounts on product advertising. In other embodiments promotion simulation may simulate the effect of varying other aspects of a trade promotion. Promotion simulation may be coupled with optimization algorithms to automatically calculate value maximizing solutions. For example, optimization may be used to calculate the discount between 0% and 30% that maximizes profit, revenue, or sales.

Optimization field 222 may identify a criterion used as a basis for the optimization algorithm. For example, if profit is selected in optimization field 222, then the promotion simulation criteria may be optimized to maximize profit. If cost is selected, then the criteria may be optimized to minimize costs. If sales is selected, then the criteria may be optimized to maximize sales, and so on. In some embodiments, the number of criteria that may be evaluated during the optimization process may be limited. The number of criteria that may be evaluated may depend on the computing resources available to the organization, as optimization calculations may be very resource intensive. Once the optimization process is complete, a list of one or more optimum criteria choices may be generated and outputted. The output limit field 223 may limit the number of optimum criteria choices outputted.

Range field 224 may limit the promotion to within a specified time period. Duration field 225 may further limit the promotion to a fixed length of time within the period specified in the range field 224. In some instances, the simulation may calculate an optimum time to conduct the promotion within the time range specified in range field 224. In other instances, the simulation may optimize other promotion criteria for each time within the time range.

As discussed previously, some of parameter fields may include common parameter fields to both forecasting and simulation analysis types. Fields such as the range 224 and duration 225 fields may be common to both forecasting and analysis types. In this situation, if a forecasting analysis is initially selected and a start and an end range are provided with a duration for the forecasting analysis, then if a subsequent forecasting or simulation analysis is performed on the same trade promotion object instance, the same start range, end range, and duration used in the prior forecasting analysis may be provided as a default start range, end range, and duration for the current analysis as well.

Other parameter fields may be unique to either forecasting or simulation analyses. For example, optimization field 222 may be limited to simulation analyses because forecasting analyses may only extrapolate data and may not offer optimization functionality. In this situation, data from optimization field 222 may only be selectable if the optimization analysis type field 221 is set to a promotion simulation type.

Parameter fields 220 may also include restriction fields 230 and causal fields 240. Restriction fields 230 may include one or fields that contain limits on the promotion criteria that may be considered during an optimization calculation. For example, the restriction field 240 may require the profit generated by the promotion to exceed a predetermined threshold. Any promotion criteria that may otherwise be valid may still be excluded from consideration if the criteria does not result in an expected profit exceeding the threshold. Restriction fields 230 may include restrictions on various aspects of the promotion, including expected profit, revenue, margins, costs associated with the promotion, and other aspects.

Causal fields 240 may include one or more fields containing other terms of the promotion, such as promotion cost terms, temporary price reduction (TPR) restrictions, market share restrictions in term of all commodity volume (ACV), and other promotion terms. Each of these terms may have an effect on the output of the trade promotion optimization analysis.

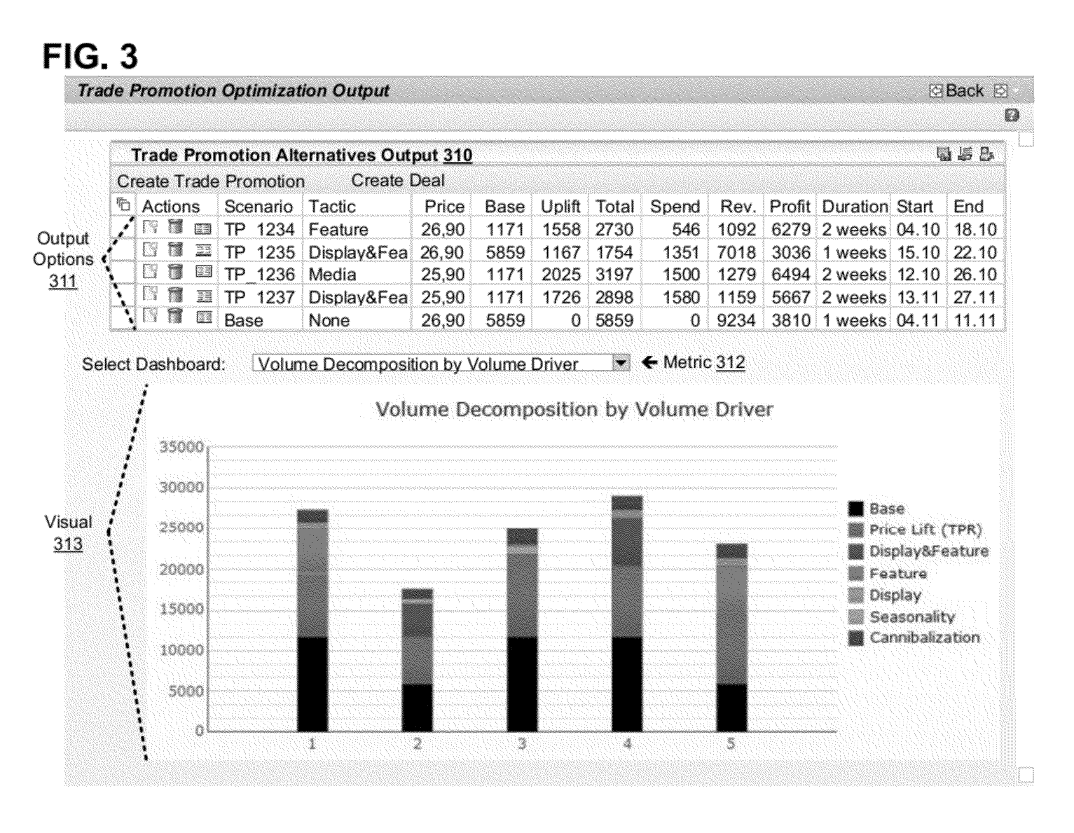

FIG. 3 shows exemplary output 310 of a trade promotion optimization object 100 displayed in a user interface of an embodiment of the invention. Output options 311 may be included in the exemplary output 310. The number of options 311 may be limited to the number of options specified in output limit field 223. Each of the options may be displayed in a chart with various other data such as pricing information, sales data including an expect base amount of sales, an expected incremental amount or uplift amount due to the promotion, an expected cost of the promotion, expected revenue and profit from the promotion, and an expect start, end, and/or duration of the promotion. The data shown in output 310 may be calculated during the analysis or may be retrieved from parameters 210 of the optimization analysis object 100.

An output metric 312 may also selected and/or changed to alter the data shown as part of the output options 311 and shown in the visual 313. The visual 313 may include a graph, chart, or other visual representation of data corresponding to the selected metric 312 for one or more of the output options 311. In this case, the metric 312 volume decomposition by volume driver is selected, so the output options 311 may include expect base sale information for each output option 311, as well as expect incremental uplift sales due to the promotion, and expected total sales data. The visual 313 may include a graph showing a expected sales volume for each output option based on different factors, such as expected sales due a temporary price reduction and expected sales due to a promotional display. Different metrics 312 may be associated with different visuals 313 and different output fields in the output options 311 so that the data included in the output 310 may vary depending on the selected metric 312.

The output options may also vary depending on whether a forecasting or simulation analysis is selected. If a forecasting analysis, such as single, multi, or scenario forecasting is selected, then the output options may include the expected effects of the one or more promotions. If a simulation analysis is selected, then only promotions having at least one optimized promotion criterion may be selected for output and shown as output option 311.

In some instances it may be possible to output both a forecasted expected effect of a particular promotion and a simulated promotion having at least one of its criterion optimized. Both the forecasted promotion and the simulated optimized promotion may be included in output 310, output options 311, and/or visual 313, to enable a comparison of the two analyses.

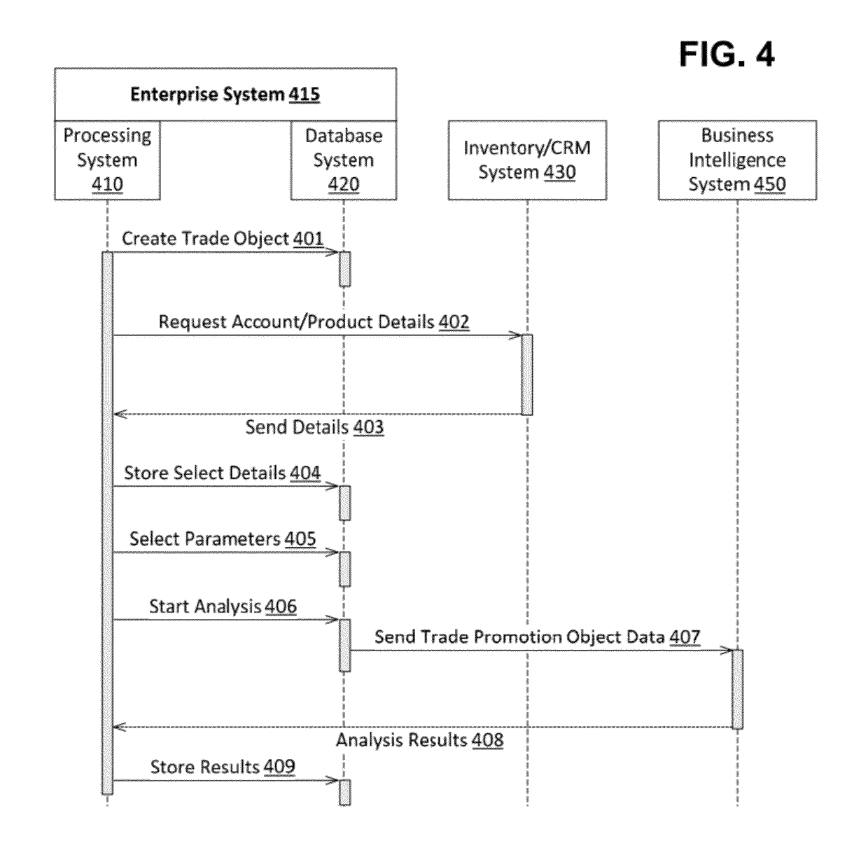

FIG. 4 shows exemplary communications between different systems in an embodiment of the invention. An enterprise system 415 may communicate with an inventory or customer relationship management (CRM) system 430 and a business intelligence system 440. An enterprise system 415 may include an enterprise resource planning (ERP) system for managing resources of the organization such as assets, financial resources, materials, and human resources. The enterprise system 415 may also include other computing systems of an organization such as a marketing system managing marketing functions of an organization or any other computing system of the organization. The enterprise system may include a processing system 410 to process data and a database system 420 to store processed data.

A CRM system may manage customer interactions using computing systems to organize, automate, and synchronize sales and customer activities in an organization. An inventory system may be used to manage products and resources in the organization. CRM and/or inventory systems may be used to identify account and/or product data to be used in a trade promotion analysis. Business intelligence system 450 may perform the actual computations and analysis of the data and report a result of the analysis.

Processing system 410 may receive a request to initiate 401 a trade promotion object. During the instantiation of the trade promotion object, the processing system 410 may request 402 account and/or product information from the inventory/CRM system 430. The inventory/CRM system 430 may send 403 the requested account/product information to the processing system 410. The sent account/product information may include identifiers for retrieving the data from the inventory/CRM system. In some instances, the sent account/product information may include actual data from the inventory/CRM system.

Once data relevant to the trade promotion is identified from the account/product information sent 403 from the inventory/CRM system, the relevant data, which may include the actual data or identifiers of the actual data, may be stored 404 in the database system 420.

The parameter 210 associated with the trade promotion analysis, such as those shown in FIG. 2, may be selected at the processing system 410 and stored 405 in the database system.

Once the processing system 410 receives a request to begin a trade promotion analysis, the processing system 410 may start 406 the analysis process by notifying the database system 420. Trade promotion object data in the database system 420 may be sent 407 from the database system 420 to the business intelligence system 450. The business intelligence system 450 may use the trade promotion optimization object data to perform the analysis specified in the type parameter field 211 using the account/product information specified in the details fields 110 and/or products field 120. Other parameters, such as parameter in other fields 210, may be used to tailor the analysis performed by the business intelligence system 450 to specific objectives.

The business intelligence system 450 may send 408 the result of its analysis to the processing system 410. The processing system 410 may reformat the results and send the reformatted results to the database system 420 to be stored 409.

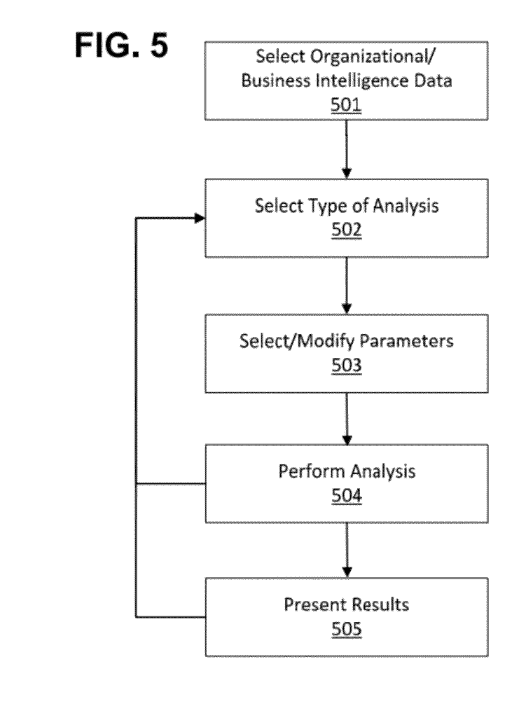

FIG. 5 shows an exemplary process in an embodiment of the invention. When analyzing organizational business intelligence data, an optimization object may be instantiated. During the instantiation process, in box 501, a subset of business intelligence data, such as an account and/or a product associated with a trade promotion, may be selected. If, for example, the business intelligence data analysis is is targeted to particular products sold at a particular retailer, then the selected account may be the particular retailer's account and the selected products may be the group of particular products.

In some embodiments this organizational data may be used by the business intelligence system to perform its analysis. The organizational data used by the business intelligence system may include the aforementioned account and product data, or it may include other data, such as point of sale data stored by the organization or one of the organization's business partners. Alternatively, in some instances, syndicated data, such as syndicated point of sale data, may be used instead of actual data. A syndicated data converter may be used during processing so that the data is properly analyzed and decoded.

In box 502, a type of analysis may be selected. As discussed previously, the types of analyses that may be selected may include forecasting and simulation options, including, in a trade promotion context, for example, single promotion forecasting, multiple promotion forecasting, scenario forecasting, and promotion simulation. Promotion simulation may be coupled with optimization algorithms to automatically calculate value maximizing options. The type of analysis may be changed at any time, whenever a new analysis is to be performed.

In box 503, other parameters associated with the selected analysis type may be selected. As discussed previous, the other parameter may include common parameter that are used in the different analyses and unique parameters that are unique to one or more analyses types. The common parameters may be displayed and may be modifiable regardless of the type of analysis that is selected. In some instances, the unique parameters may be displayed and/or modifiable only if the corresponding analysis type is selected. The values of parameters entered or modified in box 503 may be stored in the optimization object so that when subsequent analyses may be performed, the saved parameter values may be reloaded and used in the subsequent analysis if left unmodified.

In box 504, object data, such as trade promotion object data 100 may be sent a business intelligence system when other parameters have been selected, such as for example, the analysis type selected in box 502 for the account and/or products specified in box 501 subject to the parameters specified in box 503. Once the analysis is complete, in some instances the process may return to box 502 to perform a different type of analysis. In other instances, the results may be presented to a user or stored in the optimization object. Once the results have been presented, the process may return to box 502 if at least one additional analysis is desired.

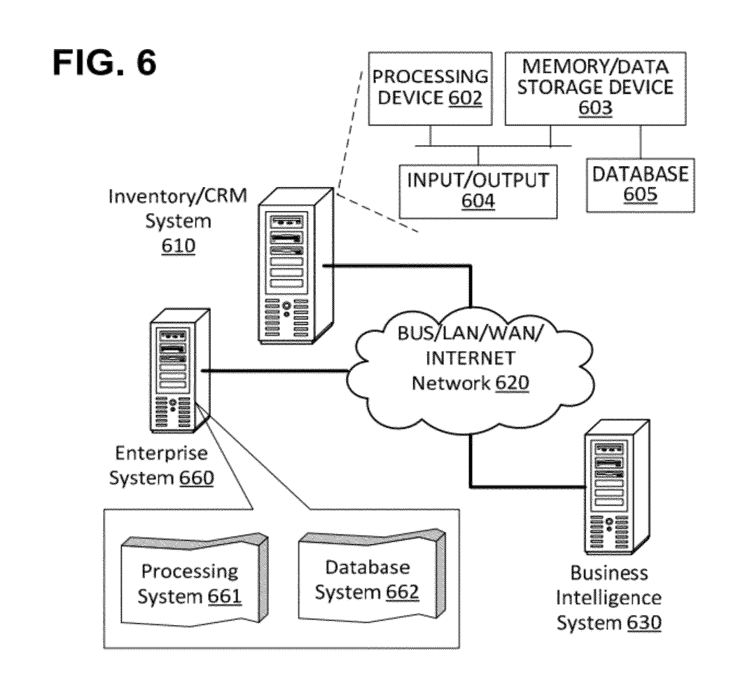

FIG. 6 shows an embodiment of an enterprise system 660 coupled to an inventory/CRM system 610, and business intelligence system 630 through a bus or network 620. In an embodiment, the enterprise system 660 may include two or more system components, including processing system 661 and database system 662. Each of these components may be on separate, independent computing systems forming an enterprise system 660, or the components 661, 662 may be consolidated or integrated into a single enterprise system 560.

Some of these system 610, 630, 660 may be connected to a firewall system (not shown), if needed, to prevent direct access to other systems of an organization.

Each of the systems in FIG. 6 may contain a processing device 602, a data storage device 603 containing a database 605, and an input/output interface 604, all of which may be interconnected via a system bus. In various embodiments, each of the systems 610, 630, 660 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 603 may contain different components for retrieving, presenting, changing, and saving data. Memory 603 may include a variety of memory devices, for example, Dynamic Random Access Memory (DRAM), Static RAM (SRAM), flash memory, cache memory, and other memory devices. Additionally, for example, memory 603 and processing device(s) 602 may be distributed across several different computers that collectively comprise a system.

Processing device 602 may perform computation and control functions of a system and comprises a suitable central processing unit (CPU). Processing device 602 may comprise a single integrated circuit, such as a microprocessing device, or may comprise any suitable number of integrated circuit devices and/or circuit boards working in cooperation to accomplish the functions of a processing device. Processing device 602 may execute computer programs, such as object-oriented computer programs. Processing device 602 may retrieve these programs from memory 603.

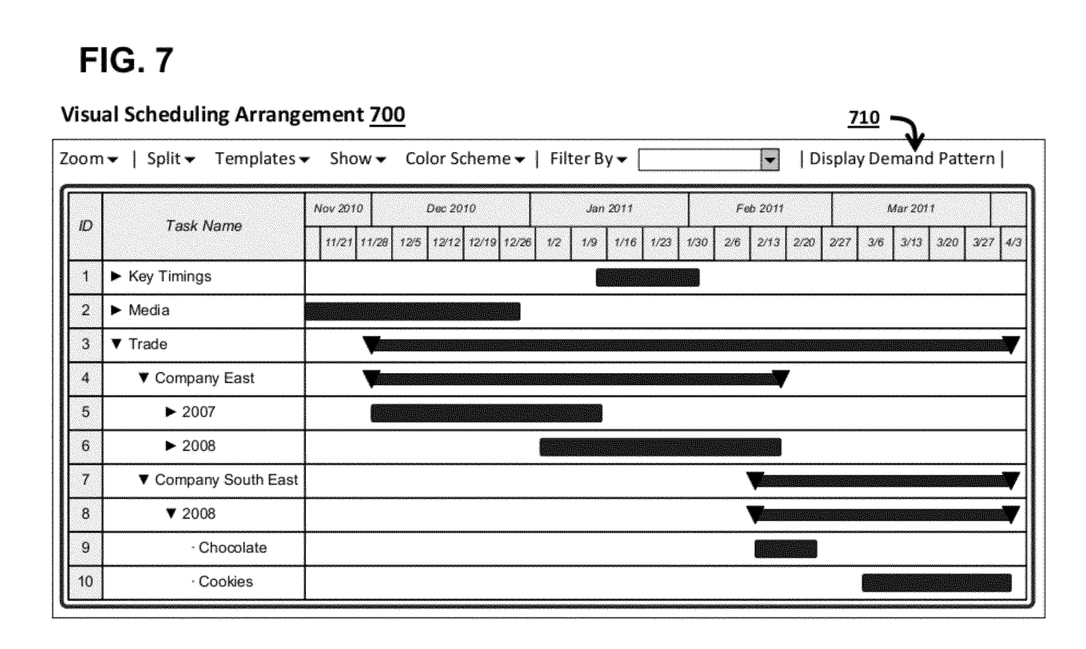

FIG. 7 shows an exemplary visual scheduling arrangement 700 displayed in a user interface that may be used by an organization to show timing associated with particular events, transactions, or activities. Although this figure shows a Gantt chart representation of the timing in different embodiments, other visual representations of time may be used, including, but not limited to calendars and timelines. Furthermore, while this figure also depicts the timing of different trade promotions, media promotions, and other key event timings, in other embodiments, different events, transactions, and/or activities may be depicted in the visual scheduling arrangement 700. An activation arrangement, in this case a display demand pattern button 710, may be included in the visual scheduling arrangement to launch an interface for selecting a forecast, simulation, or optimization model.

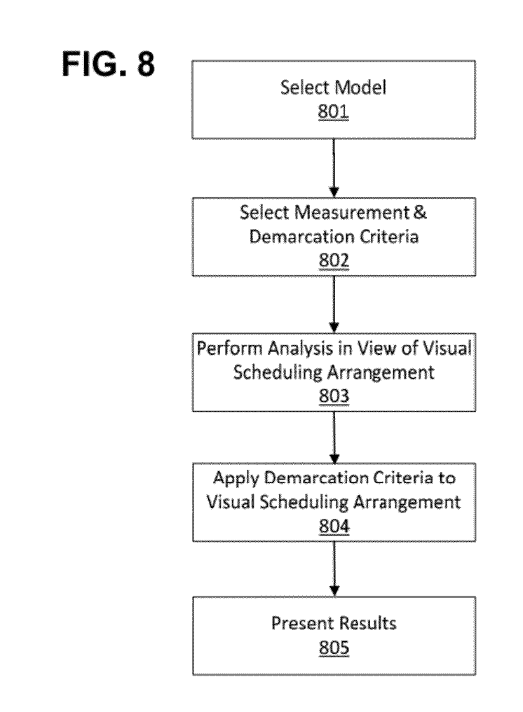

FIG. 8 shows an exemplary process for modifying the visual scheduling arrangement to show an effect of timing on the results of a predictive analytics model. A predictive analytics model may analyze an organization's business intelligence data to make predictions, and may include a forecasting, simulation, or optimization model. In the step that is illustrated by box 801, the predictive analytics model may be selected for analysis. After selecting the model, additional parameters or conditions on the model may be entered depending on desired analysis. In some embodiments, this selection process may include selecting one or more of the parameters 210 in FIG. 2 and then re-executing the model with the changed parameters. Alternatively, instead of selecting a model for analysis, the saved results of a previously executed model may be selected instead. Other modeling data may also be selected. For example, such data is commercial available from market research companies, such as Nielsen.

In the step that is illustrated by box 802, a result of the analysis and demarcation criteria may be selected. The result may include any output from the analysis. For example, if the model selected in the step that is illustrated by box 801 is a forecasting model that extrapolates expected sales, revenue, and profit, the results may include the expected sales, revenue, and profit, or some intermediate value using during the analysis to calculate the sales, revenue, and/or profit. The specific results to be considered may be selected from a list of criteria associated with the selection made in the step that is illustrated by box 801. Thus, the selection made in the step that is illustrated by box 801 may be analyzed to identify the selectable results. In the aforementioned forecasting model example, the list of selectable criteria may include expected sales, revenue, and profit.

Once the result has been selected, the demarcation criteria may also be selected. The demarcation criteria may be used to identify a set of data satisfying the results that are to be differentiated in the visual scheduling arrangement. The demarcation criteria may include a single value, such as a maximum value, a range of values, a specific pattern, or trend. For example, the demarcation criteria may be selected to identify those periods where revenue is expected to drop more than a certain amount. Multiple demarcation criteria may be selected and each may be uniquely presented in the modified visual scheduling arrangement.

In the step that is illustrated by box 803, an analysis may be performed to apply the results selected in the step that is illustrated by box 802 to the selected model and/or selected data in the step that is illustrated by box 801 in view of date ranges displayed in the visual scheduling arrangement. Thus, if the result is expected revenue and the visual scheduling arrangement is configured to show timing information for activities, events, and transactions between mid-November 2010 and early-April 2011, then the expected revenue for the period between mid-November 2010 and early-April 2011 may be calculated from the selected model and/or selected data in the step that is illustrated by box 801.

In the step that is illustrated by box 804, the demarcation criteria selected in the step that is illustrated by box 802 may be applied to the analysis performed from the applying the results in the step that is illustrated by box 803. Thus, in the case of the previous example, the demarcation criteria selected in the step that is illustrated by box 802 may be applied to expected revenue calculated in the step that is illustrated by box 803 for the date ranges displayed in the visual scheduling arrangement to identify those periods in which the expected revenue satisfies the demarcation criteria. The identified periods in the visual scheduling arrangement may then be demarcated to differentiate them from other periods according to the demarcation criteria.

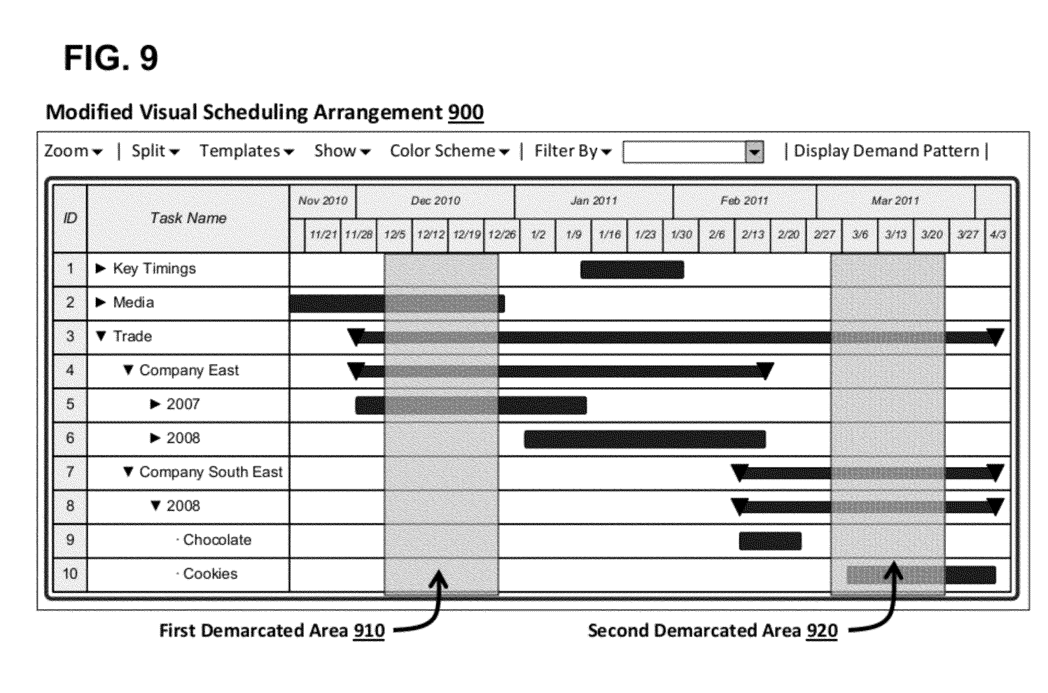

In the step that is illustrated by box 805, the modified visual scheduling arrangement with the demarcated identified periods satisfying the demarcation criteria may be present to the user. FIG. 9 shows an exemplary modified visual scheduling arrangement 900 showing two demarcated areas 910 and 920. In this example, applying a first demarcation criterion to an analysis performed in conjunction with the selected results may lead to the identification of the first demarcated area 910, as shown in the diagonally lined region. Similarly, applying the second demarcation criterion to the analysis may lead to the identification of the second demarcated area 920, as shown in the dotted region. Each demarcation criterion may coincide with a different distinguishing feature, such as the diagonal lined region for the first demarcated area 910 versus the dotted region for the second demarcated area 920. Other distinguishing features, including highlights, shading, color changes, callouts, and so on, may be used in different embodiments.

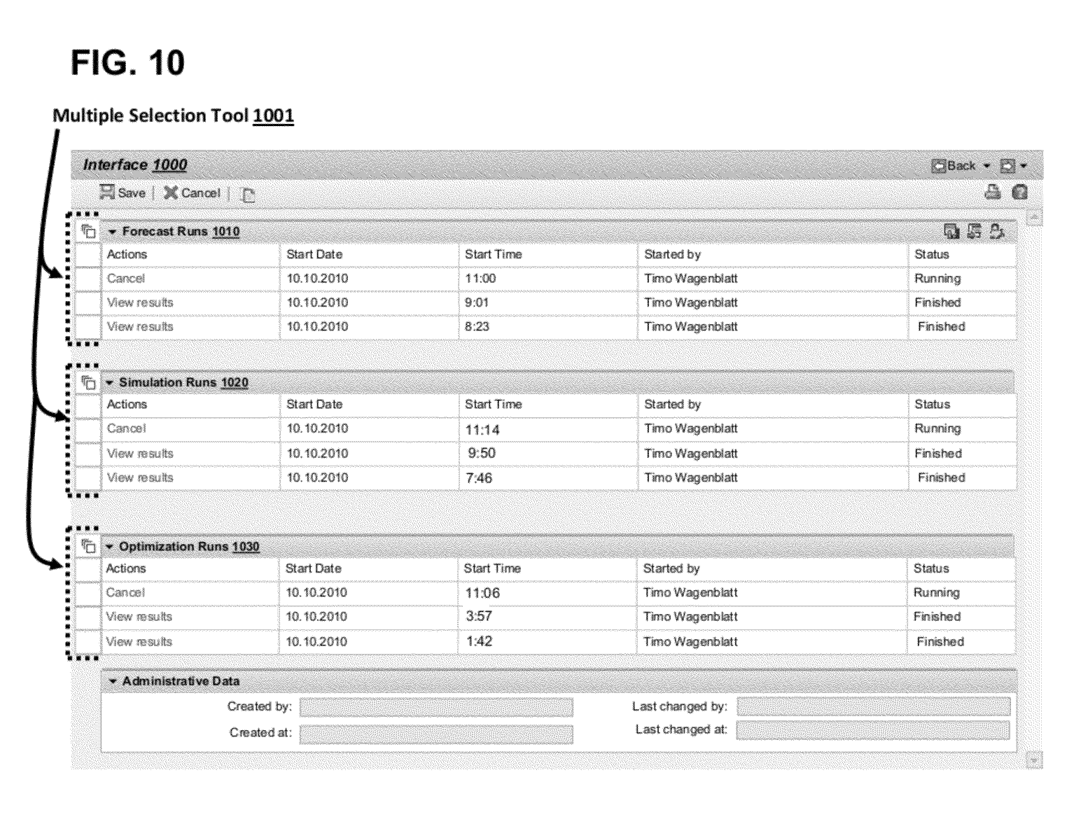

As previously discussed, in an embodiment of the invention, the parameters and results from each predictive analytics model, which may include a forecasting, simulation, and optimization model, may be saved, recalled, and/or compared on demand. FIG. 10 shows an exemplary interface 1000 for managing the retrieval and comparison of saved model parameters and results. The interface 1000 may include a list of saved forecasting models 1010, simulation models 1020, and optimization models 1030 that may be retrieved and/or compared. The multiple selection tool 1001 may enable a user to select multiple models in each model type 1010, 1020, and 1030 for comparison.

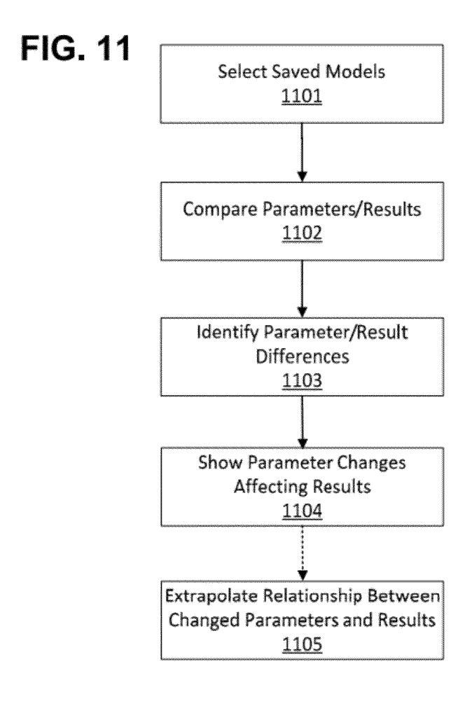

FIG. 11 shows an exemplary process for comparing the selected models in an embodiment. In box 1101, the models to be compared may be selected. This selection may be made using the multiple selection tool 1001 shown in FIG. 10, or any other selection tool or technique.

In box 1102, the parameters values and results of each model selected in box 1101 may be compared to each other. In box 1103, those parameter values and results in the compared models that are different may be identified. In box 1104, the identified differences in parameter values and results may be grouped together and shown on a screen, included in a report, transferred to another process, or stored. In box 1105, the identified differences may be further analyzed to identify a correlation between the parameter changes and corresponding result changes.

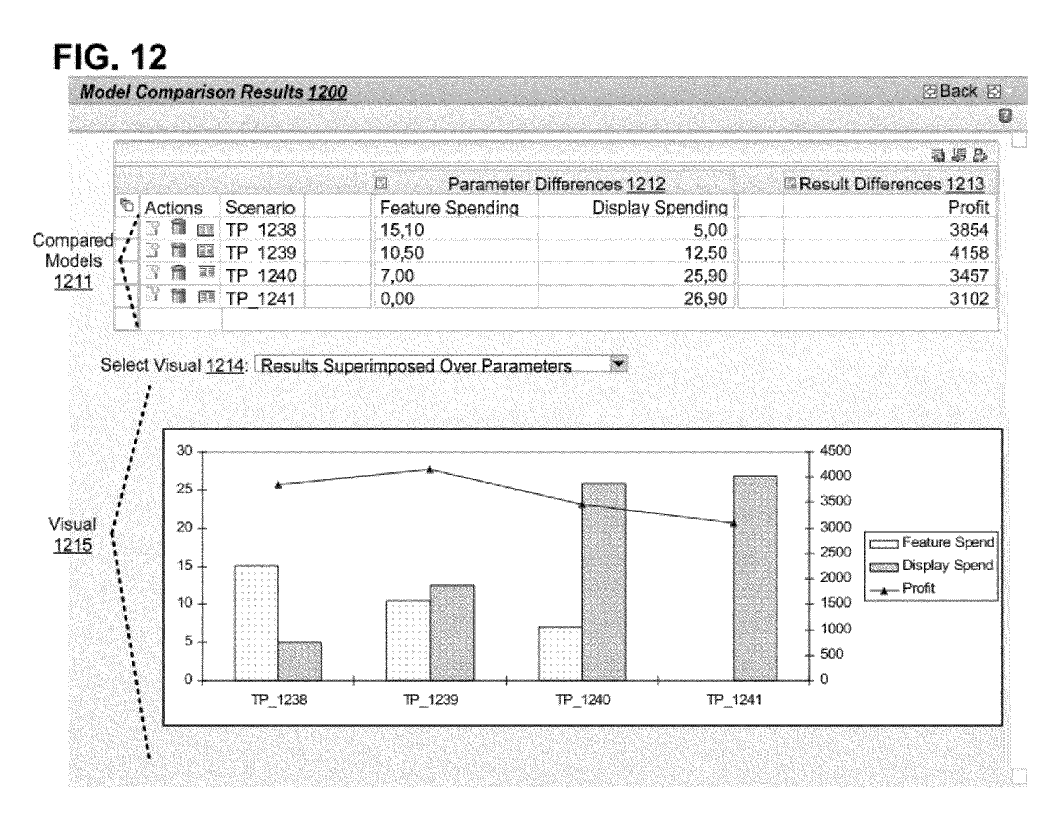

FIG. 12 shows exemplary output 1200 of comparing the parameters and results of different saved models in an embodiment. The results 1200 shown are based on comparing four different saved models, Models TP_1238, TP_1239, TP_1240, and TP_1241, which are identified in the compared model list 1211. As discussed previously, during the comparison process, the parameter values in each of models selected for comparison may be compared to identify differences in parameter values. In the example shown in FIG. 12, it is assumed that the only difference in parameter values between the four models is the amount to be spent on promotional features and the amount to be spent on promotional displays per store. If the Companyining parameters are the same in each of the four models selected for comparison, then only the Feature Spending and Display Spending parameter values may be shown as parameter differences 1212. If each of the models are configured to report results based on profit, the resulting changes in profit may be shown as result differences 1213.

In addition to output the actual values of the different parameter values 1212 and results 1213 of each compared model 1211, additional relationships between the parameter value changes and effects on the results may be shown visually in the form of a chart, graph, or other diagram 1215. Different diagram types and charts may be selected 1214 depending on the complexity of the analysis performed. For example, instead of superimposing the different profits over the feature and display expenditures, different functions and graphs may be used to show extrapolated, interpolated, smoothed, or fitted curves. Regression analyses and functions may also be used in different embodiments in preparing different diagrams and visuals 1215 to the user.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, while some people may associate the term forecasting with future events or conditions, the term forecasting may also apply in some instances to past or current events or conditions. Furthermore, while some of the previously mentioned embodiments included trade promotion data and objects, including trade promotion optimization objects, these embodiments are just one exemplary context in which the invention may be used. Embodiments of the invention may be used in other contexts and business areas beyond trade promotions. Additionally, although aspects of the present invention are described as being stored in memory, this may include other computer readable media, such as secondary storage devices, for example, hard disks, the Internet or other storage devices.

We claim:

1. A method comprising:
selecting a result from an output of a predictive analytics model, the predictive analytics model generating a prediction from an analysis of business intelligence data, the selected result including a plurality of output values distributed over time from the predictive analytics model that encompass a time period included in a visual scheduling arrangement;
selecting a demarcation criterion identifying a subset of result values;
applying, using a processing device, the selected demarcation criterion to the selected result to identify the subset of the result values that satisfy the demarcation criterion; and
demarcating, using the processing device, a time period in the visual scheduling arrangement associated with the identified subset of result values.

2. The method of claim 1, wherein the predictive analytics model is a forecasting model and the selected result includes result values extrapolated over time using the forecasting model.

3. The method of claim 1, wherein the predictive analytics model is a simulation model and the selected result includes result values simulated over time using the simulation model.

4. The method of claim 1, wherein the predictive analytics model is an optimization model and the selected result includes result values optimized over time using the optimization model.

5. The method of claim 4, further comprising configuring the optimization model to output at least one secondary optimized solution in addition to a primary optimized solution.

6. The method of claim 5, wherein the optimization model is configured to output a user-selected quantity of secondary optimization solutions.

7. The method of claim 1, wherein the time period demarcated in the visual scheduling arrangement is distinguished from other time periods according to a distinguishing feature associated with the demarcation criterion.

8. The method of claim 7, wherein the distinguishing feature includes shading the demarcated time period.

9. The method of claim 7, further comprising:
applying a plurality of selected demarcation criterion to the selected result to identify the subsets of the result to be differentiated according to each demarcation criterion; and
demarcating each time period in the visual scheduling arrangement associated with the identified subset of results to be differentiated according to the distinguishing feature associated with the respective demarcation criterion.

10. A method comprising:
selecting a plurality of predictive analytics models for comparison, each predictive analytics model including parameters limiting a scope of an analysis of business intelligence data in the model and generating a prediction as a result;
comparing, with a processing device, the results, the parameters, and values of the parameters in each of the selected models to identify those results, parameters, and values that are different in each of the models;
grouping, using the processing device, the different results, parameters, and parameter values in each of the selected models; and
outputting the grouped results, parameters, and parameter values.

11. The method of claim 10, wherein the grouping includes gathering the different results, parameters, and parameter values into a group.

12. The method of claim 10, further comprising analyzing the grouped results, parameters, and parameter values to identify a correlation between changes in parameter values and changes in corresponding results.

13. The method of claim 12, wherein the analyzing includes applying a regression function to the group results and parameter values to identify the correlation.

14. The method of claim 13, further comprising generating a diagram based on an output of the regression function to visually depict the identified correlation.

15. The method of claim 10, wherein each of the selected predictive analytics models is a forecasting model having a result including result values extrapolated over time using the forecasting model.

16. The method of claim 10, wherein each of the selected predictive analytics models is a simulation model having a result including result values simulated over time using the simulation model.

17. The method of claim 10, wherein each of the selected predictive analytics models is an optimization model having a result including result values optimized over time using the optimization model.

18. The method of claim 17, further comprising configuring the optimization model to output at least one secondary optimized solution in addition to a primary optimized solution.

19. The method of claim 18, wherein the optimization model is configured to output a user-selected quantity of secondary optimization solutions.

20. A memory device storing instructions that when executed by a processing device, cause the processing device to:
select a plurality of predictive analytics models for comparison, each predictive analytics model including parameters limiting a scope of an analysis of business intelligence data in the model and generating a prediction as a result;
compare the results, the parameters, and values of the parameters in each of the selected models to identify those results, parameters, and values that are different in each of the models;
group the different results, parameters, and parameter values in each of the selected models; and
output the grouped results, parameters, and parameter values.
